(19) United States
(12) Patent Application Publication
(10) Pub. No.: US 2026/0104935 A1
(43) Pub. Date: Apr. 16, 2026

(54) DETECTING RESOURCE LEAKAGE IN A MEMORY SUB-SYSTEM

(71) Applicant: Micron Technology, Inc., Boise, ID (US)

(72) Inventor: Qiang Cao, Shanghai (CN)

(21) Appl. No.: 19/357,289

(22) Filed: Oct. 14, 2025

Related U.S. Application Data
(60) Provisional application No. 63/707,667, filed on Oct. 15, 2024.

(51) Int. Cl. G06F 9/50

(52) U.S. Cl. CPC G06F 9/5027

(57) ABSTRACT

A system comprising a memory device and a processing device, operatively coupled with the memory device, to perform operations. The processing device detects allocation of a computing resource to a processing thread. The processing device initializes a time-to live (TTL) field of a metadata record with a pre-defined maximum TTL value, wherein the metadata record is associated with the computing resource. The processing device determines, by inspecting the metadata record, whether the TTL value satisfies a timeout threshold criterion. Responsive to determining that the metadata record fails to satisfy the timeout threshold criterion, the processing device detects a failure of the processing thread to release the computing resource.

### RELATED

This application claims the benefit of U.S. Provisional Patent Application No. 63/707,667 filed Oct. 15, 2024, entitled “Detecting Resource Leakage in a Memory Sub-system” which is incorporated by reference herein.

### TECHNICAL FIELD

Embodiments of the disclosure relate generally to memory sub-systems, and more specifically, relate to detecting resource leakage in a memory sub-system.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example computing system that includes a memory sub-system, in accordance with some embodiments of the present disclosure.

FIG. 2 is a flow diagram of an example method to detect resource leakage in a memory sub-system, in accordance with some embodiments of the present disclosure.

FIG. 3 is a diagram of an example metadata table, in accordance with some embodiments of the present disclosure.

FIG. 4 is a block diagram of an example computer system in which embodiments of the present disclosure may operate.

### DETAILED DESCRIPTION

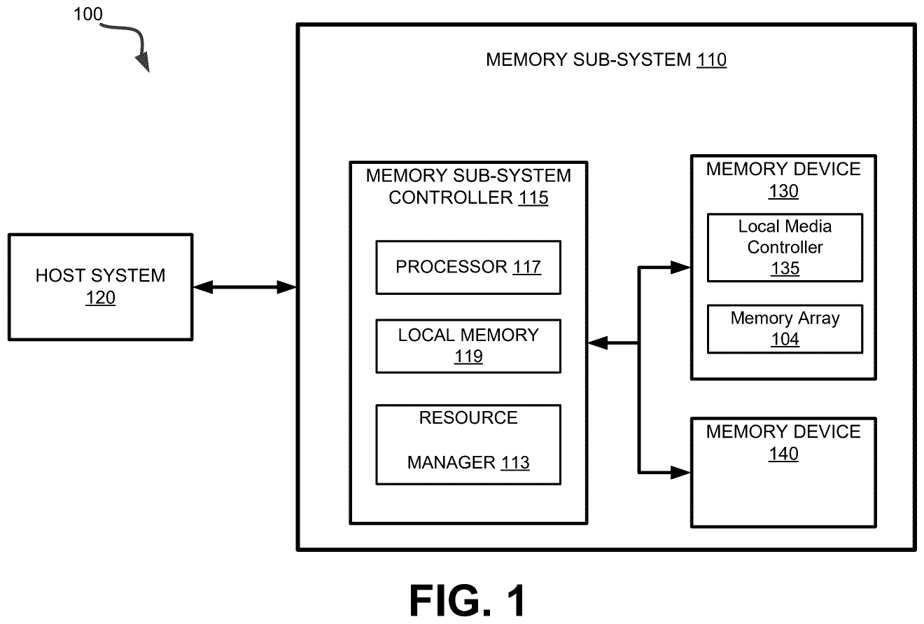

Aspects of the present disclosure are directed to detecting resource leakage in a memory sub-system. A memory sub-system can be a storage device, a memory module, or a combination of a storage device and memory module. Examples of storage devices and memory modules are described below in conjunction with FIG. 1. In general, a host system can utilize a memory sub-system that includes one or more components, such as memory devices that store data. The host system can provide data to be stored at the memory sub-system and can request data to be retrieved from the memory sub-system.

A memory sub-system can include high density non-volatile memory devices where retention of data is desired when no power is supplied to the memory device. One example of non-volatile memory devices is a not-and (NAND) memory device. Other examples of non-volatile memory devices are described below in conjunction with FIG. 1. A non-volatile memory device is a package of one or more dies. Each die can include of one or more planes. For some types of non-volatile memory devices (e.g., NAND devices), each plane includes of a set of physical blocks. Each block includes of a set of pages. Each page includes of a set of memory cells (“cells”). A cell is an electronic circuit that stores information. Depending on the cell type, a cell can store one or more bits of binary information, and has various logic states that correlate to the number of bits being stored. The logic states can be represented by binary values, such as “0” and “1”, or combinations of such values.

A memory device can include multiple memory cells arranged in a two-dimensional or a three-dimensional grid. The memory cells can be formed onto a silicon wafer in an array of columns and rows. A bitline can refer to one or more conductive lines coupled to a column of associated memory cells in a memory device. A wordline can refer to one or more conductive lines coupled to a row of associated memory cells in a memory device that are used with one or more bitlines to generate the address of each of the memory cells. The intersection of a bitline and a wordline constitutes the address of the memory cell. A block hereinafter refers to a unit of the memory device used to store data and can include a group of memory cells, a wordline group, a wordline, or individual memory cells. One or more blocks can be grouped together to form separate partitions (e.g., planes) of the memory device in order to allow concurrent operations to take place on each plane. The memory device can include circuitry that performs concurrent memory page accesses of two or more memory planes. For example, the memory device can include multiple access line driver circuits and power circuits that can be shared by the planes of the memory device to facilitate concurrent access of pages of two or more memory planes, including different page types. For ease of description, these circuits can be generally referred to as independent plane driver circuits. Depending on the storage architecture employed, data can be stored across the memory planes (i.e., in stripes). Accordingly, one request to read a segment of data (e.g., corresponding to one or more data addresses), can result in read operations performed on two or more of the memory planes of the memory device.

Resource leakage can be caused by a failure of a resource consumer (e.g., a processing thread) to release a computing resource (e.g., a memory buffer) even if the resource is no longer needed, thus rendering the resource unavailable for other potential consumers. Such inefficient resource management, which often remains undetected until the problem occurs, can lead to a situation where a system runs out of resources. Thus, reactive detection of resource leakage can lead to operational delays and potential system downtime.

Aspects of the present disclosure address the above and other deficiencies by having a memory sub-system that proactively detects resource leakage. Specifically, in an embodiment, the memory sub-system can maintain (e.g., in a metadata structure) information regarding the allocation of each resource to a corresponding operation (e.g., a write operation, a read operation, etc.). Each metadata record of the metadata structure (e.g., an entry of a metadata table) can include a “Time to Live” (TTL) field with a predefined maximum TTL value. In some embodiments, this metadata record further includes information such an in-use status of the resource, an identifier of the operation utilizing the resource, and/or an identifier of the processing thread performing the operation. The system proactively scans each metadata record to test for the occurrence of resource leakage and uses the information of the metadata record to locate the source of the leakage before resource depletion can occur. In some embodiments, if a metadata record is determined to be associated with a resource leakage, the system logs an error.

In some embodiments, the TTL value is initialized to a predefined maximum value based on the current time (e.g., the system time) plus an allowed duration for resource usage, effectively setting a deadline for the resource's release. In this approach, the TTL value represents a maximum time point beyond which the computing resource should no longer be retained by the resource consumer. The processing logic checks if the current time has surpassed this TTL value, and upon finding a resource is allocated to a resource consumer beyond its allotted time, the system detects a failure to release the resource (e.g., the failure of a threshold criterion) and the metadata record being scanned is determined to be associated with a resource leakage.

In some embodiments, The TTL value is initialized to a predefined maximum value when the resource is allocated and subsequently decremented at a predetermined frequency (e.g., at every “tick” of a system timer). In some embodiments, this maximum value can vary depending on the operation being performed by the resource consumer. If the TTL value reaches zero and the computing resource is still allocated to the resource consumer, the system detects a failure to release the resource and the metadata record being scanned is determined to be associated with a resource leakage.

Advantages of the present disclosure include, but are not limited to mitigating the impact of resource leakage through this proactive approach and significantly decreasing the time needed to locate the source of the resource leakage. The present disclosure facilitates early detection of resource leakage in the memory sub-system. This proactive detection prevents the complete depletion of resources, which traditionally goes unnoticed until it causes operational delays or system downtime. In addition, the present disclosure eliminates the need for manual troubleshooting of resource leakage, improving efficiency.

FIG. 1 illustrates an example computing system 100 that includes a memory sub-system 110 in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a combination of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to multiple memory sub-systems 110 of different types. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller, CXL controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a compute express link (CXL) interface, a peripheral component interconnect express (PCIe) interface, universal serial bus (USB) interface, Fibre Channel, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access components (e.g., memory devices 130) when the memory sub-system 110 is coupled with the host system 120 by the physical host interface (e.g., PCIe or CXL bus). The physical host interface can provide an interface for passing control, address, data, and other signals between the memory sub-system 110 and the host system 120. FIG. 1 illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include a not-and (NAND) type flash memory and write-in-place memory, such as a three-dimensional cross-point (“3D cross-point”) memory device, which is a cross-point array of non-volatile memory cells. A cross-point array of non-volatile memory cells can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 130 can include one or more arrays of memory cells. One type of memory cell, for example, single level cells (SLC) can store one bit per cell. Other types of memory cells, such as multi-level cells (MLCs), triple level cells (TLCs), quad-level cells (QLCs), and penta-level cells (PLCs) can store multiple bits per cell. In some embodiments, each of the memory devices 130 can include one or more arrays of memory cells such as SLCs, MLCs, TLCs, QLCs, PLCs or any combination of such. In some embodiments, a particular memory device can include an SLC portion, and an MLC portion, a TLC portion, a QLC portion, or a PLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as a 3D cross-point array of non-volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), not-or (NOR) flash memory, or electrically erasable programmable read-only memory (EEPROM).

A memory sub-system controller 115 (or controller 115 for simplicity) can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can include a processing device, which includes one or more processors (e.g., processor 117), configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1 has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory devices 130. The memory sub-system controller 115 can be responsible for other operations such as wear leveling operations, garbage collection operations, error detection and error-correcting code (ECC) operations, encryption operations, caching operations, and address translations between a logical address (e.g., a logical block address (LBA), namespace) and a physical address (e.g., physical block address) that are associated with the memory devices 130. The memory sub-system controller 115 can further include host interface circuitry to communicate with the host system 120 via the physical host interface. The host interface circuitry can convert the commands received from the host system into command instructions to access the memory devices 130 as well as convert responses associated with the memory devices 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory devices 130.

In some embodiments, the memory devices 130 include local media controllers 135 that operate in conjunction with memory sub-system controller 115 to execute operations on one or more memory cells of the memory devices 130. An external controller (e.g., memory sub-system controller 115) can externally manage the memory device 130 (e.g., perform media management operations on the memory device 130). In some embodiments, memory sub-system 110 is a managed memory device, which is a raw memory device 130 having control logic (e.g., local media controller 135) on the die and a controller (e.g., memory sub-system controller 115) for media management within the same memory device package. An example of a managed memory device is a managed NAND (MNAND) device.

The memory sub-system 110 includes a resource manager component 113 that can proactively detect resource leakage. In some embodiments, the memory sub-system controller 115 includes at least a portion of the resource manager component 113. In some embodiments, the resource manager component 113 is part of the host system 120, an application, or an operating system. In other embodiments, local media controller 135 includes at least a portion of resource manager component 113 and is configured to perform the functionality described herein.

The resource manager component 113 can proactively detect resource leakage. Specifically, in an embodiment, the memory sub-system can maintain (e.g., in a metadata structure) information regarding the allocation of each resource to a corresponding operation (e.g., a write operation, a read operation, etc.). Each metadata record of the metadata structure (e.g., an entry of a metadata table) can include a TTL field with a predefined maximum TTL value. In some embodiments, this metadata record further includes information such an in-use status of the resource, an identifier of the operation utilizing the resource, and/or an identifier of the processing thread performing the operation. The system proactively scans each metadata record to test for the occurrence of resource leakage and uses the information of the metadata record to locate the source of the leakage before resource depletion can occur. In some embodiments, if a metadata record is determined to be associated with a resource leakage, the system logs an error.

In some embodiments, the TTL value is initialized to a predefined maximum value based on the current time (e.g., the system time) plus an allowed duration for resource usage, effectively setting a deadline for the resource's release. In this approach, the TTL value represents a time point beyond which the computing resource should no longer be retained by the resource consumer. The processing logic checks if the current time has surpassed this TTL value, and upon finding a resource is allocated to a resource consumer beyond its allotted time, the system detects a failure to release the resource (e.g., the failure of a threshold criterion) and the metadata record being scanned is determined to be associated with a resource leakage.

In some embodiments, The TTL value is initialized to a predefined maximum value when the resource is allocated and subsequently decremented at a predetermined frequency (e.g., at every “tick” of a system timer). In some embodiments, this maximum value can vary depending on the operation being performed by the resource consumer. If the TTL value reaches zero and the computing resource is still allocated to the resource consumer, the system detects a failure to release the resource and the metadata record being scanned is determined to be associated with a resource leakage.

Further details with regards to the operations of the resource manager component 113 are described below.

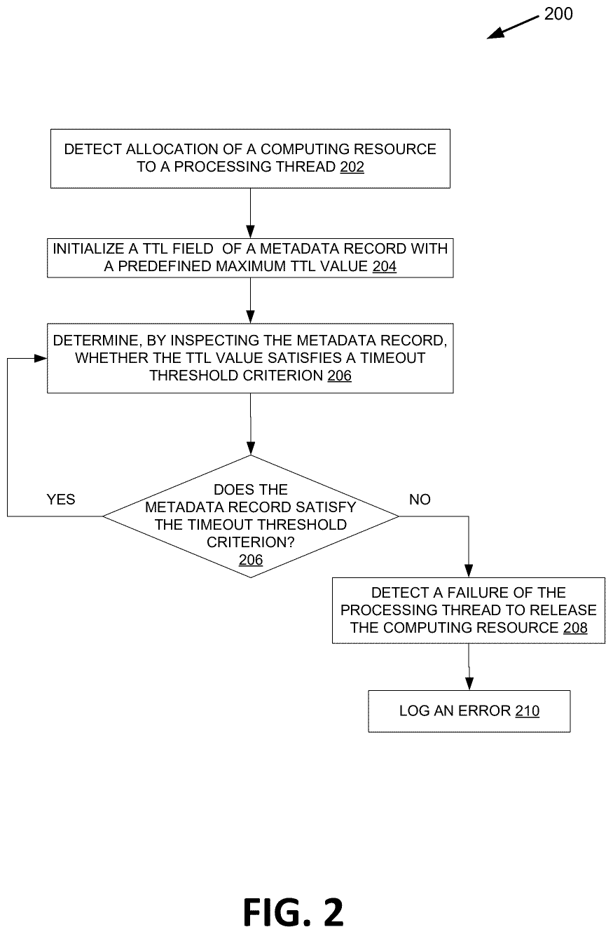

FIG. 2 is a flow diagram of an example method 200 to detect resource leakage in a memory sub-system, in accordance with some embodiments of the present disclosure. The method 200 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 200 is performed by the resource manager component 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 202, the processing logic (e.g., resource manager component 113) detects allocation of a computing resource to a processing thread. In some embodiments, control logic on the memory device includes a number of separate processing threads to perform concurrent memory access operations (e.g., read operations, program operations, and erase operations). For example, each processing thread corresponds to a respective hardware component (e.g., a memory plane) and performs the memory access operations on the respective hardware component. In some embodiments, a processing thread corresponds to a computing resource.

In some embodiments, to detect the allocation, the processing logic intercepts a corresponding resource allocation application programming interface (API) call. Using the API call the processing logic can determine information about the allocation such as the processing thread that issued the call and the operation being performed. For example, the resource allocation API call can be used in conjunction with an annotated memory map to determine the operation performed. An annotated memory map is a detailed representation of a system's memory layout, storing memory address ranges and providing additional descriptive information about contents of the memory device, such as code, data, stack, heap, and hardware-specific allocations.

In some embodiments, the computing resource (“resource”) is a data buffer. A Data Buffer can be used as an intermediary storage area that temporarily holds data during various input/output operations, including reading from or writing operations. In an example embodiment, the buffer capacity includes 4096 bytes for storing basic data and an additional 256 bytes for additional data such as error-correcting code (ECC) data or other control information.

In some embodiments, the computing resource is a system array manager. A system array manager is a specialized memory buffer that manages information about data buffers, organizing, tracking, and controlling buffer usage, locations, and statuses. In some embodiments, a system array manager comprises 256 bytes or less.

In some embodiments, the computing resource is a message buffer. Message buffers are primarily utilized to store short messages for communication protocols, error logging, or inter-thread communications within multitasking environments. In some embodiments, a message buffer comprises 128 bytes or less.

At operation 204, the processing logic initializes a time-to live (TTL) field of a metadata record with a pre-defined maximum TTL value, wherein the metadata record is associated with the computing resource. In some embodiments, when a computing resource is allocated, its corresponding metadata record in the metadata table is updated to reflect its in-use status.

In some embodiments, the pre-defined maximum TTL value can be initialized based on the current time plus an allowed duration for resource usage, effectively setting a deadline for the resource's release. In this approach, the TTL value represents a maximum time point beyond which the resource should no longer be retained. In some embodiments, the TTL value is initially set to a predefined maximum value when the resource is allocated. In this approach, the TTL value functions as a counter that is to be subsequently decremented at a predetermined frequency.

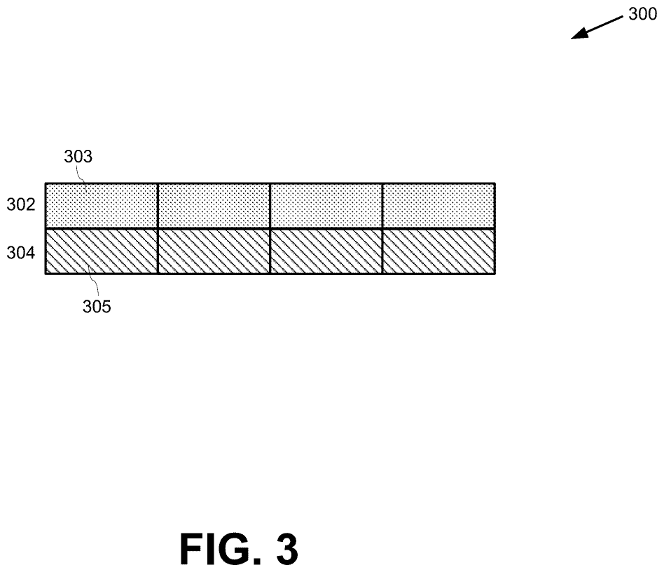

FIG. 3 is a diagram of an example metadata table 300, in accordance with some embodiments of the present disclosure. FIG. 3 depicts a metadata table 300 that comprises entries such as metadata record 303 in row 302 and metadata record 305 in row 304. In some embodiments, the metadata table is volatile memory. In some embodiments, the memory device is configured as contiguous memory, wherein the series of memory addresses (e.g., memory addresses for the metadata records) stored in the metadata table are sequentially adjacent, allowing for straightforward indexing.

The metadata record 303 represents an example of a metadata record associated with a first resource. The metadata record 305 represents an example of a metadata record associated with a second resource. For example, metadata record 303 can be associated with a data buffer while metadata record 305 is associated with a system array manager. In some embodiments, multiple resources are represented by the metadata records in the metadata table. In some embodiments, the number of metadata records associated with each resource varies. In some embodiments, the number of metadata records associated with each resource is consistent. In some embodiments, a single row in the metadata table can represent multiple computing resources. For example, row 302 can comprise metadata records of the resource type of metadata record 303 and metadata record 305.

In some embodiments, the metadata record further comprises an in-use status. In some embodiments, the in-use status appears in the metadata table as a bit in memory. For example, when a resource numbered 200 is allocated, the corresponding metadata record address is 200*8=800 in the metadata table. The processing logic can set a bit corresponding to address 0x800 with a “1” to indicate resource numbered 200 is in use. When the resource numbered 200 is released (e.g., deallocated from the processing thread), the processing logic sets a bit corresponding to address 0x800 with a “0” to indicate the resource is no longer in-use (i.e. deallocated).

In some embodiments, the metadata record further comprises an identifier of the operation utilizing the resource. An operation is performed by the processing thread. For example, in some embodiments, operations can include write operations, read operations, etc. In some embodiments, the metadata record further comprises an identifier of the processing thread. In some embodiments, the processing thread identifier is a pointer directed to the processing thread performing the operation. In some embodiments, during resource allocation, an instruction pointer (IP) of the processing thread responsible for the allocation is known. The IP contains the memory address of the instruction that is executed immediately after the allocation is completed. By utilizing an annotated memory map specific to the processing thread, which maps memory addresses to their corresponding functions or operations, the function or operation that initiated the allocation (e.g., read operation, write operation, etc.) can be identified and the information used to populate a corresponding field of a metadata record. This process takes place within the firmware of the memory sub-system, which operates on the memory sub-system controller 115 or a local memory controller. The firmware is responsible for managing resource allocations and other low-level operations within the memory controller.

At operation 206, the processing logic determines, by inspecting the metadata record, whether the TTL value satisfies a timeout threshold criterion. In some embodiments, the timeout threshold criterion is based on the TTL value (e.g., the pre-defined maximum TTL value).

In some embodiments, the processing logic maintains a current time (e.g., a system timer), wherein the current time is a real-time clock in the system. This real-time clock runs continuously from the moment the system is powered on. For example, when the system is initially powered on, the current time initializes to 0:00:00. From that point, an internal clock keeps track of the time that has passed. For instance, if the system has been running for 1 hour, 30 minutes, and 10 seconds, the current time displayed would be 01:30:10. If an additional 2 hours and 15 minutes pass, the current time is 03:45:10, reflecting the total elapsed time since the system was turned on.

In some embodiments, the timeout threshold criterion is an expected release time relative to the current time at the point of allocation (i.e., the TTL value). In some embodiments, the TTL value is set only once during the allocation of the resource based on the formula: TTL value=(current time)+(timeout duration). In some embodiments, the timeout duration is the maximum duration of time a resource should be allocated to a processing thread to perform an operation. In some embodiments, the timeout duration is based on the type of the operation. For example, more complex or critical operations can be assigned a longer timeout duration to ensure they complete successfully, while simpler tasks can have a shorter timeout duration to prevent unnecessary tying up of resources. In some embodiments the timeout duration values are predefined in the firmware code and stored in the firmware image.

For example, if the current time is 01:30:10 and the timeout duration for that operation is 10 seconds, the TTL value for this resource would be set to 01:30:20. This is calculated by adding the 10-second timeout duration to the current time, moving from 01:30:10 to 01:30:20, effectively setting a deadline for when the resource should be released.

As time progresses, the system's internal clock continuously updates, incrementally increasing the current time. As stated, resource leakage occurs when resources, such as a data buffer, remain allocated after their intended use period. This can lead to system inefficiencies, reduced performance, and even failures as available resources become increasingly scarce. To prevent this, at operation 206, the processing logic inspects the metadata record to determine whether the metadata record fails to satisfy a timeout threshold criterion.

In an embodiment where the pre-defined maximum TTL value can be initialized based on the current time plus an allowed duration for resource usage, satisfying the timeout threshold criterion entails that the current time does not exceed the TTL value. Failing to satisfy the timeout threshold criterion entails that the current time exceeds the TTL value. In some embodiments, satisfying the timeout threshold criterion further includes that the metadata record is marked as in-use in the metadata record.

In some embodiments, the timeout threshold criterion is directly tied to the decremental counting of a pre-defined maximum TTL value. The TTL value is set to a predefined maximum when a resource is allocated. This TTL value is subsequently decremented at a predetermined frequency. In some embodiments, the TTL value is decremented with every “tick” the current time increases.

For example, if a resource is allocated for an operation expected to last 100 ticks, the TTL value for this resource would be initially set at 100. With each tick of the current time, the TTL value is decremented by one, counting down from 100 to 0.

In some embodiments, the TTL value initialized in the TTL field (e.g., the maximum TTL value) is based on the type of the operation. For example, more time-intensive or critical operations can be assigned a greater TTL value to ensure they complete successfully, while operations that require less time can have a smaller TTL value to prevent unnecessary tying up of resources. In some embodiments the TTL values are defined in the firmware code and stored in the firmware image.

In some embodiments, satisfying the timeout threshold criterion means that the TTL value has not yet reached zero. Failing to satisfy the timeout threshold criterion occurs when the TTL value reaches zero while the computing resource is allocated to a processing thread, indicating a failure to release the resource as expected and thus, resource leakage. In some embodiments, satisfying the timeout threshold criterion further includes that the metadata record is marked as in-use in the metadata record.

In some embodiments, the metadata record is inspected at a specified frequency. The processing logic generates interruptions at specified intervals along the current time. An interruption provides a regular checkpoint at which the system evaluates the status of resources, with each interruption triggering a scan of one or more metadata records of the metadata table. For example, where the processing logic is configured to generate interruptions at 20 ms intervals, the processing logic inspects one or more metadata records in the metadata table every 20 ms for situations where the timeout threshold criterion is not satisfied.

In some embodiments, the inspection of all metadata records in the metadata table is spread across multiple interruptions to avoid overwhelming the system. For example, from FIG. 3, and using a 20 ms interruption interval, the processing logic inspects the metadata records across row 302 of the metadata table 300 at 20 ms. At 40 ms the processing logic generates a second interruption and inspects the metadata records across row 304 of the metadata table 300.

Responsive to determining that the metadata record fails to satisfy the timeout threshold criterion (for example, the current time exceeds the TTL value for a metadata record), at operation 208, the processing logic detects a failure of the processing thread to release the computing resource.

In some embodiments, responsive to determining that the metadata record fails to satisfy the timeout threshold criterion, at operation 210, the processing logic logs an error. In some embodiments, the processing logic automatically records the error in a firmware log. In some embodiments, this firmware log is located in the volatile memory device 140. The log can store data about the resource leakage from the metadata record. For example, in some embodiments, this metadata record includes information such as the maximum TTL value, an in-use status of the resource, an identifier of the operation utilizing the resource, and/or an identifier of the processing thread performing the operation. The host system can then retrieve the data in this log to analyze and diagnose the cause of the resource leakage. In some embodiments, the processing logic returns an error to a host as the error is discovered (e.g., the TTL value is exceeded).

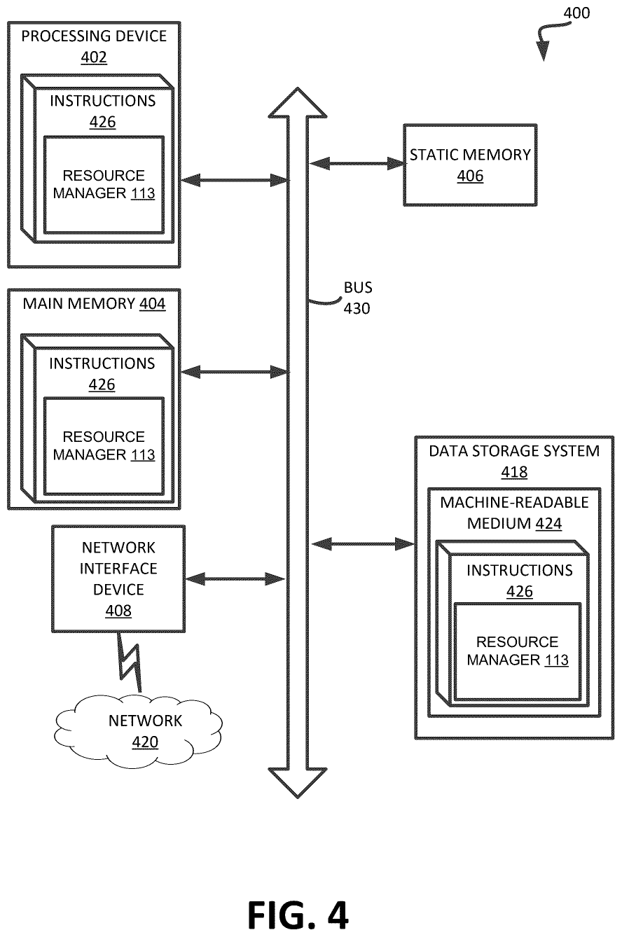

FIG. 4 illustrates an example machine of a computer system 400 within which a set of instructions, for causing the machine to perform any one or more of the methodologies discussed herein, can be executed. In some embodiments, the computer system 400 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the resource manager component 113 of FIG. 1). In alternative embodiments, the machine can be connected (e.g., networked) to other machines in a LAN, an intranet, an extranet, and/or the Internet. The machine can operate in the capacity of a server or a client machine in a client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 400 includes a processing device 402, a main memory 404 (e.g., read-only memory (ROM), flash memory, dynamic random access memory (DRAM) such as synchronous DRAM (SDRAM) or RDRAM, etc.), a static memory 406 (e.g., flash memory, static random access memory (SRAM), etc.), and a data storage system 418, which communicate with each other via a bus 430.

Processing device 402 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 402 can also be one or more special-purpose processing devices such as an application specific integrated circuit (ASIC), a field programmable gate array (FPGA), a digital signal processor (DSP), network processor, or the like. The processing device 402 is configured to execute instructions 426 for performing the operations and steps discussed herein. The computer system 400 can further include a network interface device 408 to communicate over the network 420.

The data storage system 418 can include a machine-readable storage medium 424 (also known as a computer-readable medium) on which is stored one or more sets of instructions 426 or software embodying any one or more of the methodologies or functions described herein. The instructions 426 can also reside, completely or at least partially, within the main memory 404 and/or within the processing device 402 during execution thereof by the computer system 400, the main memory 404 and the processing device 402 also constituting machine-readable storage media. The machine-readable storage medium 424, data storage system 418, and/or main memory 404 can correspond to the memory sub-system 110 of FIG. 1.

In one embodiment, the instructions 426 include instructions to implement functionality corresponding to a resource manager component (e.g., the resource manager component 113 of FIG. 1). While the machine-readable storage medium 424 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A system, comprising:
a memory device; and
a processing device, operatively coupled with the memory device, to perform operations comprising:
detecting allocation of a computing resource to a processing thread;
initializing a time-to live (TTL) field of a metadata record with a pre-defined maximum TTL value, wherein the metadata record is associated with the computing resource;
determining, by inspecting the metadata record, whether the TTL value satisfies a timeout threshold criterion; and
responsive to determining that the metadata record fails to satisfy the timeout threshold criterion, detecting a failure of the processing thread to release the computing resource.

2. The system of claim 1, the operations further comprising:
responsive to determining that the metadata record fails to satisfy the timeout threshold criterion, logging an error.

3. The system of claim 1, wherein the metadata record is inspected at a specified frequency.

4. The system of claim 1, wherein the metadata record further comprises an in-use status of the computing resource and an identifier of the processing thread.

5. The system of claim 1, wherein the metadata record further comprises an identifier of an operation utilizing the computing resource.

6. The system of claim 1, wherein the computing resource is a data buffer.

7. The system of claim 1, wherein the computing resource is a system array manager.

8. The system of claim 1, wherein the computing resource is a message buffer.

9. The system of claim 1, wherein the TTL value is determined based on a type of an operation utilizing the computing resource.

10. A method comprising:
detecting, by a processing device, allocation of a computing resource to a processing thread;
initializing a time-to live (TTL) field of a metadata record with a pre-defined maximum TTL value, wherein the metadata record is associated with the computing resource;
determining, by inspecting the metadata record, whether the TTL value satisfies a timeout threshold criterion; and
responsive to determining that the metadata record fails to satisfy the timeout threshold criterion, detecting a failure of the processing thread to release the computing resource.

11. The method of claim 10, further comprising:
responsive to determining that the metadata record fails to satisfy the timeout threshold criterion, logging an error.

12. The method of claim 10, wherein the metadata record is inspected at a specified frequency.

13. The method of claim 10, wherein the metadata record further comprises an in-use status of the computing resource and an identifier of the processing thread.

14. The method of claim 10, wherein the metadata record further comprises an identifier of an operation utilizing the computing resource.

15. The method of claim 10, wherein the computing resource is a data buffer, a system array manager, or a message buffer.

16. The method of claim 10, wherein the TTL value is determined based on a type of an operation.

17. A non-transitory computer-readable storage medium comprising instructions that, when executed by a processing device, cause the processing device to perform operations comprising:
detecting allocation of a computing resource to a processing thread;
initializing a time-to live (TTL) field of a metadata record with a pre-defined maximum TTL value, wherein the metadata record is associated with the computing resource;
determining, by inspecting the metadata record, whether the TTL value satisfies a timeout threshold criterion; and
responsive to determining that the metadata record fails to satisfy the timeout threshold criterion, detecting a failure of the processing thread to release the computing resource.

18. The non-transitory computer-readable storage medium of claim 17, wherein the metadata record is inspected at a specified frequency.

19. The non-transitory computer-readable storage medium of claim 17, wherein the metadata record further comprises an in-use status of the computing resource and an identifier of the processing thread.

20. The non-transitory computer-readable storage medium of claim 17, wherein the metadata record further comprises an identifier of an operation utilizing the computing resource.
